(19) United States
(12) Patent Application Publication
(10) Pub. No.: US 2002/0190134 A1
(43) Pub. Date: Dec. 19, 2002

(54) Method of maintaining a yard having a sprinkling system

(76) Inventor: Michael W. Johnson, Colorado Springs, CO (US)

Correspondence Address: Glen F. Gallinger, 7420 Milner Dr., #1000, Colorado Springs, CO, 80920, US

(21) Appl. No.: 09/878,956

(22) Filed: Jun. 13, 2001

(51) Int. Cl. B05B 7/26

(52) U.S. Cl. 239/10; 239/310; 239/317

(57) ABSTRACT

A safe and convenient method of applying chemicals—i.e. fertilizers, pesticides, or herbicides—to lawns through, and in conjunction with a central sprinkling system. Most basically, the water feed line to the underground sprinkling system is broken and a chemical dilution apparatus is inserted therein so that water feeding the underground sprinkling system will contain a solution of the chemical. The chemical dilution apparatus comprises a venturi having a high pressure outlet in the line upstream of the venturi, and a low pressure water inlet in the line downstream of the venturi so that a selected portion of the water in the feed line may be circulated around the venturi through a container having chemical therein. In one embodiment of the invention the container has an open top portion having a peripheral thread for screwed attachment. In an alternative embodiment the container comprises a pail which is attached to a housing around the venturi with a hose.

### FIELD OF THE INVENTION

This invention relates to the application of fertilizer, pesticides, and herbicides to lawns. More particularly this invention relates to a safe and convenient method of applying chemicals to lawns through, and in conjunction with a central sprinkling system.

### BACKGROUND OF THE INVENTION

Today, more than ever before there is a necessity to reduce and eliminate the labor involved in broadcasting chemicals unto a lawn. This necessity arises not only from the insufficient supply and the consequent rising cost of labor; but also, from documented health risks to individuals resulting from exposure to the chemicals which are being broadcast. Numerous studies have proven substantial physiological ailments and nervous problems, as well as increased incidence of cancer resulting from the exposure to chemicals. The damage caused by pesticides and herbicides is now intuitively obvious. Health risks related to fertilizer exposure are now also documented.

The applicant has been intimately involved in the lawn care industry. There are numerous hand held devices available enabling individuals to broadcast chemicals in an immediate proximity to themselves. The problem with all of these devices is that the individuals are exposed to airborne chemicals. An unexpected puff of gentle breeze may substantially expose and contaminate even the most diligent and health conscious individual. There has been a longstanding and unmet need for a safer, and less labor intensive system of applying chemicals to a lawn.

### OBJECTS OF THE INVENTION

It is an object of this invention to disclose a safe method of applying chemicals to a lawn. A method which will minimally expose the individual to airborne chemicals, and a method which will thereby minimize long term health hazards associated with exposure to chemicals. It is an object of this invention to disclose a method of applying chemicals to a lawn which by minimizing the labor involved will be relatively inexpensive. It is a final object of this invention to disclose a method using an apparatus which can be retrofitted on an existing lawn sprinkling system to facilitate the safe and convenient application of chemicals to a lawn.

One aspect of this invention provides for a method of broadcasting chemicals for lawn maintenance into and through a water feed line for an underground water sprinkling system, comprising the step of breaking and connecting a chemical dilution apparatus into the water feed line of the underground water sprinkling system. Then water feeding the underground sprinkling system will contain a solution of the chemical and the chemical will be broadcast over the lawn while watering the lawn.

In a preferred aspect of this apparatus the chemical dilution apparatus comprises a venturi having a high pressure outlet in the line upstream of the venturi, and a low pressure water inlet in the line downstream of the venturi. Then a selected portion of the water in the feed line may be circulated around the venturi through a water tight container having the chemical therein.

Various other objects, advantages and features of this invention will become apparent to those skilled in the art from the following description in conjunction with the accompanying drawings.

### FIGURES OF THE INVENTION

FIG. 1 is a perspective view of a chemical dilution apparatus used in a method of broadcasting chemicals for lawn maintenance into and through a water feed line of an underground water sprinkling system.

FIG. 2 is a cross sectional view of the venturi of the apparatus taken along line 2-2 in FIG. 1.

FIG. 3 is an enlarged perspective view of varying sizes of jets which facilitate varying dilutions of the chemical and the application over extended periods of time.

FIG. 4 is a cross sectional view of an adaptor which enables the connection with a flexible hose to a pail of chemical.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

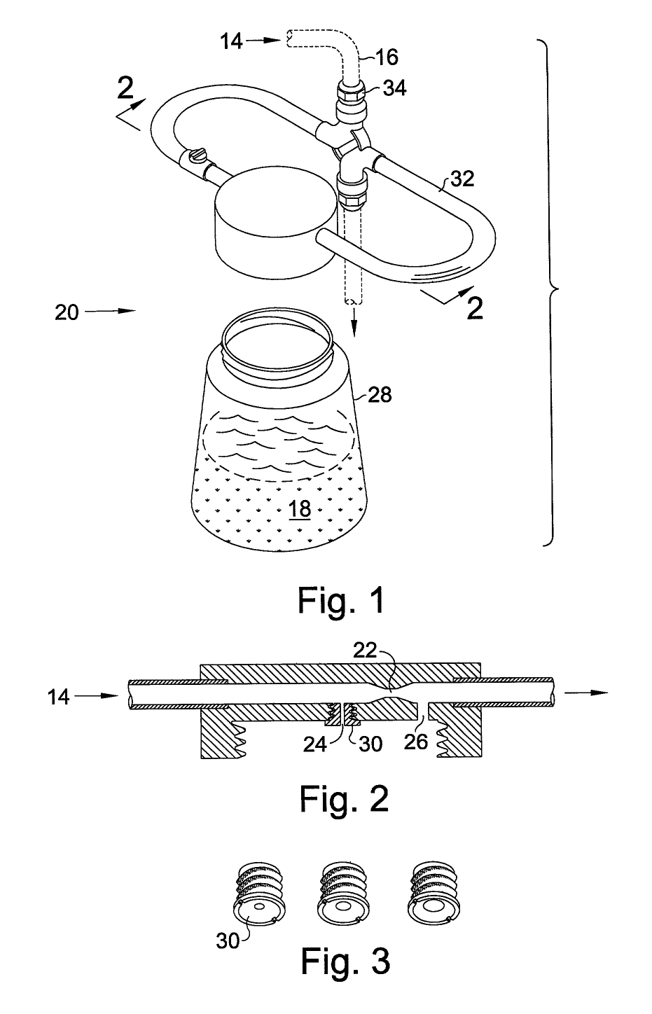

Turning now to the drawings and more particularly to FIG. 1 we have a perspective view of an apparatus 20 used in a method of broadcasting chemicals 18 for lawn maintenance into and through a water feed line 16 of an underground water sprinkling system. Most basically the method comprises the step of breaking and connecting the chemical dilution apparatus 20 into the water feed line 16 of the underground water sprinkling system. This results in water 14 which feeds the underground sprinkling system containing a solution of the chemical 18, and that chemical 18 being broadcast when watering is done.

FIG. 2 is a cross sectional view of the venturi 22 of the apparatus 20 taken along line 2-2 in FIG. 1. Most preferably, the chemical dilution apparatus 20 comprises a venturi 22 having a high pressure outlet 24 in the line upstream of the venturi 22, and a low pressure water inlet 26 in the line downstream of the venturi 22. This allows a selected portion of the water 14 to be circulated around the venturi 22. That portion of water bypassing the venturi 22 is circulated through a water tight container 28 having the chemical 18 therein. The chemical 18 may be either liquid or solid granules.

FIG. 3 is an enlarged perspective view of varying sizes of jets 30 which facilitate varying dilutions of the chemical 18 and the application of the chemical 18 over extended and varying periods of time. Typically a complete lawn watering cycle has a duration of approximately two or more hours. Consequently to ensure full coverage chemical 18 must be added for a period of two or more hours. The preferred method, further comprises the step of providing an interchangeable jet 30 in the flow of water bypassing the venturi 22 so that the circulating flow of water bypassing the venturi 22 and passing through the water tight container 28 which has the chemical therein may be thereby calibrated and controlled with respect to flow.

In one of the most preferred embodiments of the invention an upright portion of the water feed line 16 is broken for connection to the chemical dilution apparatus 20. A lateral flow loop 32 is provided in the chemical dilution apparatus 20 and the venturi 22 is positioned in the lateral flow loop 32. The container 28 is sealably and removably attached, most preferably by screwing, beneath the lateral flow loop 32 adjacent to the venturi 22. The water 14 bypassing the venturi 22 is arranged to circulate through the container 28. The container 28 may be removed for filling and refilling with the chemical 18. Most preferably, the chemical dilution apparatus 20 is connected to the upright feed line 16 with compression fittings 34.

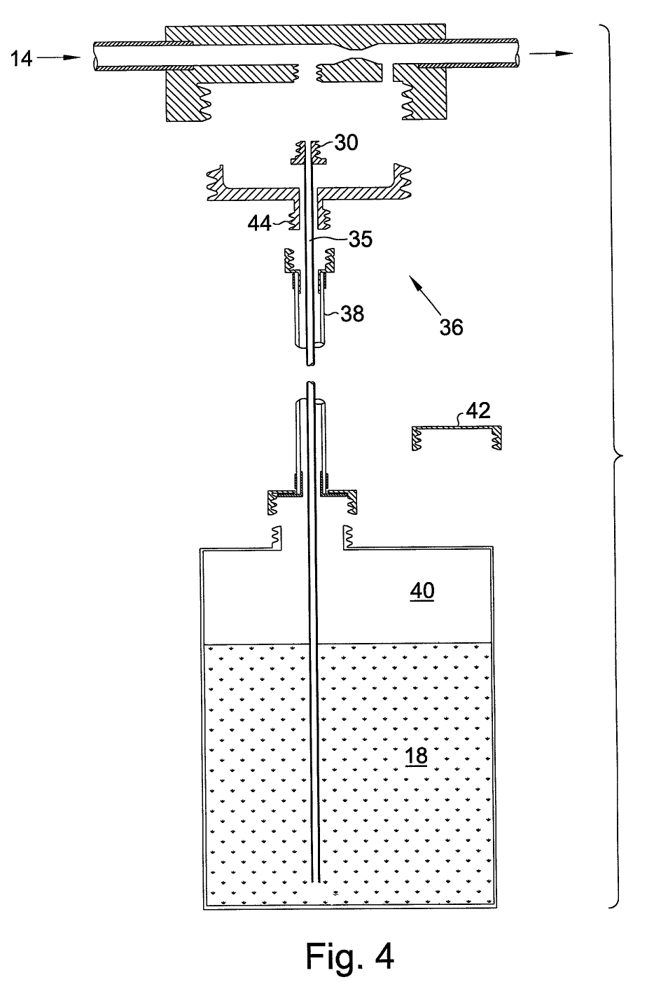

FIG. 4 is a cross sectional view of an adaptor 36 which enables the connection with a flexible hose 38 to a pail of chemical 40. An alternative embodiment of the invention further comprises the step of connecting a small water feed tube 35 to the high pressure outlet 24 in the line upstream of the venturi 22 and a hose 38 to the low pressure water inlet 26 in the line downstream of the venturi 22. Both the tube 35 and the hose 38 are connected to the water tight container 28 having the chemical 18 therein. Most preferably, the small tube 35 is positioned within the hose 38. One end portion of the hose 38 is sealably connected to the water tight container 28, and the other end portion thereof is sealably connected to a portion of housing 44 around the venturi 22 ported to the low pressure inlet 26. This arrangement, using a hose 38 to sealably connect to the container 18, allows chemical 18 to be supplied in a 5 gallon pail 40, having a screwed cap 42 thereon, and used directly therefrom, without the need for repeatedly refilling a smaller container 28.

While the invention has been described with preferred specific embodiments thereof, it will be understood that this description is intended to illustrate and not to limit the scope of the invention, which is defined by the following claims.

I claim:

1) A method of broadcasting chemical for lawn maintenance into and through a water feed line for an underground water sprinkling system, comprising the steps of:
breaking and connecting a chemical dilution apparatus into the water feed line of the underground water sprinkling system;
so that water feeding the underground sprinkling system will contain a solution of the chemical and so that the chemical will be broadcast while watering.

2) A method as in claim 1 wherein the chemical dilution apparatus comprises a venturi having a high pressure outlet in the line upstream of the venturi, and a low pressure water inlet in the line downstream of the venturi; so that a selected portion of the water in the feed line may be circulated around the venturi;
and further comprising the step of circulating that portion of water bypassing the venturi through a water tight container having the chemical therein.

3) A method as in claim 2 further comprising the step of providing an interchangeable jet in the flow of water bypassing the venturi so that the circulating flow of water bypassing the venturi and passing through the water tight container having the chemical therein may be thereby controlled and calibrated.

4) A method as in claim 3 wherein an upright portion of the water feed line is broken for connection to the chemical dilution apparatus and further comprising the steps of providing a lateral flow loop in the chemical dilution apparatus and positioning the venturi in the lateral flow loop thereof.

5) A method as in claim 4 further comprising the step of sealably attaching the container having chemical therein beneath the lateral flow loop adjacent to the venturi; and arranging for the water bypassing the venturi to circulate through the container.

6) A method as in claim 5 further comprising the step of providing a peripherally threaded top opening on the container and sealably a nd removably screwing the container beneath the venturi so that the container may be removed for filling with the chemical.

7) A method as in 6 further comprising the step of providing a water feed shut off valve upstream to the high pressure outlet so that the valve may be closed when the container is removed.

8) A method as in claim 4 wherein the chemical dilution apparatus is connected to the upright feed line with compression fittings.

9) A method as in claim 2 further comprising the step of connecting a small water feed tube to the high pressure outlet in the line upstream of the venturi and a hose to the low pressure water inlet in the line downstream of the venturi and feeding these lines to the water tight container having the chemical therein.

10) A method as in claim 9 further comprising the step of positioning the small tube within the hose and further ensuring that the hose is sealably connected to the water tight container on one end portion, and to the low pressure inlet on the other end portion so that the water tight container may be sealably connected around the venturi in the water feed line by sealably connecting only the hose therebetween.

11) A method as in claim 10 further comprising the step of providing an interchangeable jet in the flow of water bypassing the venturi so that the circulating flow of water bypassing the venturi and passing through the water tight container having the chemical therein may be thereby controlled and calibrated.

12) A method as in claim 11 wherein the container for the chemical is a 5 gallon pail, having a screwed cap thereon, in which the chemical is supplied.
